(19) United States
(12) Patent Application Publication
(10) Pub. No.: US 2024/0226838 A9
(43) Pub. Date: Jul. 11, 2024

(54) SEPARATING AND STRIPPING ENCLOSURE WITH A DEBRIS FILTRATION GRILLE

(71) Applicant: TotalEnergies OneTech, Courbevoie (FR)

(72) Inventors: Lassad REZGUI, Bondy (FR); Sébastien DECKER, Octeville-sur-Mer (FR)

(73) Assignee: TotalEnergies OneTech, Courbevoie (FR)

(21) Appl. No.: 18/269,210

(22) PCT Filed: Dec. 21, 2021
(86) PCT No.: PCT/FR2021/052413

§ 371 Date: Jun. 22, 2023

(30) Foreign Application Priority Data
Dec. 23, 2020 (FR) FR2014103

(51) Int. Cl. B01J 8/00; B01D 45/16; B01D 50/20; B01J 8/18

(52) U.S. Cl. CPC B01J 8/005; B01D 45/16; B01D 50/20; B01J 8/1872; B01J 2208/00761

(57) ABSTRACT

An enclosure for separating and stripping an effluent containing particles includes a side wall defining an internal volume having a longitudinal axis and, inside the internal volume, a separating section and a stripping section for stripping particles downstream of the separating section relative to the circulation of the particles inside the enclosure. The enclosure includes, upstream of the stripping section or a zone of the stripping section provided with stripping elements extending through the internal cross-section of the enclosure, at least one grille extending transversely to the longitudinal axis, and the projection of a single grille or all the grilles onto a transverse plane perpendicular to the longitudinal axis covers 80 to 100% of the internal cross-section of the enclosure.

The object of the invention is a separation and stripping enclosure, in particular for effluent coming from a fluidised-bed catalytic cracking unit, comprising a debris filtration grille.

Separation and stripping enclosures are generally used in fluidised-bed catalytic cracking or FCC methods. In these enclosures, the effluent leaving the catalytic cracking reactor is separated from the particles that it contains, namely coked catalytic particles, which undergo a stripping operation before being sent to the regenerator of the FCC unit in order to be regenerated therein by combustion of the coke.

These separation and stripping enclosures, also referred to as a “disengager/stripper”, thus normally comprise at least one particle separation system and a particle stripping section located downstream of the at least one separation system with respect to the circulation of the particles inside the enclosure, generally from top to bottom. It may however happen that pieces of coke and/or of a protective cladding covering the internal face of the side wall of the separation and stripping enclosure detach and fall, then being located in the stripping section. Such pieces present in this stripping section may degrade the stripping process, particularly when the stripping section contains structured internal elements, also referred to as “linings” or “packings”, and which may be blocked by these pieces.

However, in an FCC unit, it is essential to separate as effectively as possible the hydrocarbons trapped in the coked catalyst grains. Insufficient stripping of the coked grains gives rise to an increased entrainment of cracked hydrocarbons trapped in the porous system of the catalyser to the regenerator, leading to an increase in the temperature of the regenerator. Such an increase may lead to a reduction in the output of the cracking unit, to an increase in the production of dry gases, to the need to reduce the quantity of heavy load (atmospheric residue, etc.) that can be processed in the unit, to a loss of production of expected converted products such as C₃ to C₄ olefins, gasoline and gasoil bases. Furthermore, overheating of the regenerator could cause metallurgical damage in extreme cases and accelerated deactivation of the catalyst. Moreover, partial blocking of the stripper restricts the cross section of passage of the catalyst and therefore the circulation flow thereof (and therefore its stripping efficacy, etc.).

When the stripper is equipped with internal elements with a more open cross section of passage than structured packings (baffles for example), the fall of large pieces of coke/debris coming from the reactor may pass through the internal elements of the stripper and enter the standpipe located at the bottom of the stripper and bringing the stripped catalyst to the regenerator. In severe cases, the quantity of debris may be such that it causes total or partial blocking of the standpipe and of the valve regulating the speed of circulation of the catalyst that it generally contains, which may lead to a stoppage of the circulation of catalyst and therefore of the FCC unit. US2005040075A1 describes a stripping device having a grille for recovery of coke debris and of refractory material located at the outlet of the stripping zone, downstream of the internal elements present in this zone. This approach does not prevent the blocking of the internal elements of the stripper located upstream of this recovery system and therefore does not avoid the problem described above.

There is therefore a need for protecting the stripping section of a separation and stripping enclosure of an FCC unit.

For this purpose, an enclosure for separating and stripping an effluent containing particles is proposed, including a side wall delimiting an internal volume having a longitudinal axis and, inside the internal volume, a particle separation section and a particle stripping section located downstream of the separation section with respect to the circulation of the particles inside the enclosure.

According to the invention, the enclosure comprises, upstream of the stripping section or of a zone of the stripping section provided with stripping elements extending across the internal cross section of the enclosure, at least one grille extending transversely to the longitudinal axis. It may include a single grille or two or more grilles. According to the invention, the projection of a single grille or of all the grilles onto a transverse plane perpendicular to the longitudinal axis covers 80 to 100% of the internal cross section of the enclosure. Thus from 80 to 100% of the cross section of the inside (measured perpendicularly to the longitudinal axis) is covered by the single grille or by the superimposition of all the grilles.

The grille or grilles will make it possible to retain some of the pieces of coke and/or of cladding coming from the upper part of the enclosure and prevent them from entering the stripping section, thus reducing the risks of disturbance of the stripping operation.

The projection of the grille or grilles may extend across the whole of the internal cross section of the enclosure. This may however be difficult to achieve when the space available is small, in particular because of the presence of internal equipment of the particle-separation device type, reactor, etc.

Advantageously, the projection of a single grille or of all the grilles onto a transverse plane perpendicular to the longitudinal axis will be able to cover from 80 to 100% of the surface of an internal free volume of the enclosure projected along the longitudinal axis in the plane of the single grille or in the plane of the proximal grille of the stripping section or of the zone of the stripping section provided with stripping elements (the lowest grille). This internal free volume of the enclosure is defined as a part of the internal volume of the enclosure devoid of any equipment other than a grille according to the invention and located upstream of the single grille or of the proximal grille. In other words, the grille or grilles do not then necessarily extend under the equipment present inside the enclosure along the longitudinal axis. The geometry of the grille or grilles will thus be able to depend on the geometry of the equipment present inside the enclosure, in particular in the separation section thereof.

Generally, it will be possible to provide one or more grilles, typically one or two grilles. When two grilles or more are provided, they can preferably be disposed at different positions along the longitudinal axis. When two grilles or more are provided, the projections thereof onto a transverse plane perpendicular to the longitudinal axis may overlap partly or not.

Advantageously, said at least one grille, and in particular each grille, can extend continuously over at least 300° around the longitudinal axis and the projection thereof onto a transverse plane perpendicular to the longitudinal axis may cover at least part of the internal cross section of the enclosure and extend radially over at least a part of the distance separating the longitudinal axis from the side wall of the enclosure. This can facilitate the positioning of the grille inside the enclosure, in particular when the internal volume of the enclosure is encumbered by equipment.

Advantageously, the projection of said at least one grille may cover a part of the internal cross section of the enclosure extending radially over only a part of the distance separating the longitudinal axis of the side wall of the enclosure.

This part can in particular be selected from:
a central part extending radially from the longitudinal axis towards the side wall of the enclosure, and
an annular peripheral part extending radially from the side wall of the enclosure towards the longitudinal axis.

It will in particular be possible to provide a grille of each type, these grilles been located at different positions along the longitudinal axis so that the projection of these two grilles covers all or a major part (80% or more) of the internal cross section of the enclosure.

The stripping section of an FCC unit in general has a part provided with stripping elements the function of which is to promote contact between the stripping fluid and the solid particles to be stripped. The stripping elements may be baffles or linings, called “packing” in English, located upstream (with respect to the direction of circulation of the particles) of the main injection system for the stripping fluid, which circulates in counterflow to the particles. The stripping elements extend across the internal cross section of the enclosure and can be distributed in several stages along the longitudinal axis of the enclosure. Examples of packings are described in the documents EP719850, U.S. Pat. Nos. 7,022,221, 7,077,997 and WO2007/094771, WO00/35575, CN1763150, EP1577368, EP1577368A1. A stripping section may comprise one or more other stripping fluid injection systems located between stages of stripping elements and/or at the entry to the stripping section, and therefore upstream of the stripping elements. The solid particles entering the stripping section thus first pass through a stripping element located furthest upstream of the stripping section with respect to the circulation of the particles.

When the zone of the stripping section provided with stripping elements has an entry face defining openings in a plane perpendicular to the longitudinal axis, said at least one grille can advantageously be formed from a plurality of intersecting walls defining meshes and the dimensions of a mesh, measured in a plane perpendicular to the longitudinal axis, can advantageously be less than the dimensions of an opening in the zone of the stripping section, measured in a plane perpendicular to the longitudinal axis. Thus, the grille allows only debris to pass the dimensions of which are less liable to block the openings of the stripping element furthest upstream.

Whatever the embodiment, said at least one grille can be formed by a plurality of intersecting walls defining meshes and these walls can extend parallel or substantially parallel to the axis of the enclosure. In this way the impact of the grille on the circulation of the stripping fluid and of the cracked hydrocarbons inside the enclosure is reduced. When the grille is located in a particle circulation zone, this arrangement also reduces the impact of the grille on the circulation of the particles and limits the erosion of the grille by them.

Whatever the embodiment, said at least one grille can be formed by a plurality of intersecting walls defining meshes and adjacent meshes can have wall portions with different heights measured parallel to the longitudinal axis. This can make it possible to limit the return of pieces of coke/debris outside the grille. Such a return may result from a bounce when they fall or vibrations of the plant, in particular when the grille extends in a horizontal plane.

At least one grille from said at least one grille may have a cone or truncated cone shape splaying from upstream to downstream with respect to the circulation of the particles. The grille is thus inclined with respect to the longitudinal axis, promoting the discharge of the debris towards the side wall of the enclosure and retention thereof. This type of grille will therefore preferably be secured to the side wall of the enclosure, in particular only thereto, the debris then accumulating between the edge of the grille and the side wall of the enclosure and leaving clear the centre of the enclosure for circulation of fluids. Thus, preferably, this type of grille will be able to extend radially from the side wall towards the longitudinal axis over a part of the distance separating the side wall from the longitudinal axis, in particular over 360° around the longitudinal axis.

The angle at the top of a grille in the form of a cone or truncated cone can be from 20° to 70°, preferably from 30° to 50°.

At least one grille from said at least one grille may be a planar grille that extends in a plane perpendicular to the longitudinal axis. This type of grille may be secured solely to the side wall or solely to at least one separation device located in the separation section.

Generally, whatever the embodiment, said at least one grille may be secured solely to the side wall of the enclosure. Alternatively, when the separation section comprises a plurality of separation devices distributed around the longitudinal axis, said at least one grille may be secured solely to at least two separation devices, or even to at least four securing devices, optionally to each of the separation devices. Furthermore, advantageously, said at least one grille may not extend beyond the separation devices radially, which can reduce the risks of vibration of the grille. In other words, the grille then extends solely between the separation devices, at a distance from the side wall.

When the separation devices are each provided with a conduit for discharging the particles to the stripping section, generally extending parallel or substantially parallel to the longitudinal axis, such as cyclones, said at least one grille may be secured solely to at least two discharge conduits, or even to at least four discharge conduits, optionally to each discharge conduit.

Depending on the position of the grille inside the enclosure and the elements present in the separation section, it may be necessary to provide orifices through the grille.

Thus, when the separation section comprises at least one separation device, said at least one grille may include at least one orifice through which said at least one separation device passes. This orifice may in particular surround the separation device at a distance from the latter corresponding to an expansion clearance. In this way the grille coming into contact with the separation device at the orifice will be avoided. In particular, when the separation device is a separation device provided with a discharge conduit to the stripping section, this conduit generally extending parallel or substantially parallel to the longitudinal axis, the orifice may have the discharge conduit passing through it. When the enclosure comprises a separation device extending along the longitudinal axis, the orifice may then be central for surrounding this separation device.

Furthermore, when the separation section comprises at least one separation device provided with a conduit for discharging the particles to the stripping section, generally extending parallel or substantially parallel to the longitudinal axis, said at least one grille may be located downstream of the discharge conduit of said at least one separation device. It may then include an orifice located under the discharge conduit of said at least one separation device in a direction parallel to the longitudinal axis. This facilitates the passage of the particles leaving these discharge conduits through the grille but especially limits the erosion and the degradation of the grille through the flow of solid particles that would pass through it in the absence of this orifice. In this case, the grille can advantageously be located just below the ends of the discharge conduit or conduits, so that the orifices are located as close as possible to the ends of these discharge conduits, but however at a distance greater than the movement of a valve secured to the end of the discharge conduit.

However, preferably, for better operation of the stripping section, said at least one grille may be located upstream of an end of the particle discharge conduit of at least one separation device of the separation section, or even upstream of the ends of the discharge conduits of all the separation devices of the separation section.

It should be noted that it will nevertheless be possible to provide a plurality of grilles, one or more of which are located upstream of an end of the particle discharge conduit of at least one separation device of the separation section, and one or more grilles located downstream of this end.

The invention thus describes the use of one or more grilles in a separation and stripping enclosure for an effluent containing particles, the grille or grilles being as previously described and positioned as previously described. The grille or grilles are able to (make it possible to) retain pieces of coke and/or cladding coming from the upper part of the enclosure and prevent them from entering the stripping section, thus reducing the risks of disturbance of the stripping operation.

The invention is now described with reference to the accompanying non-limitative drawings, wherein:

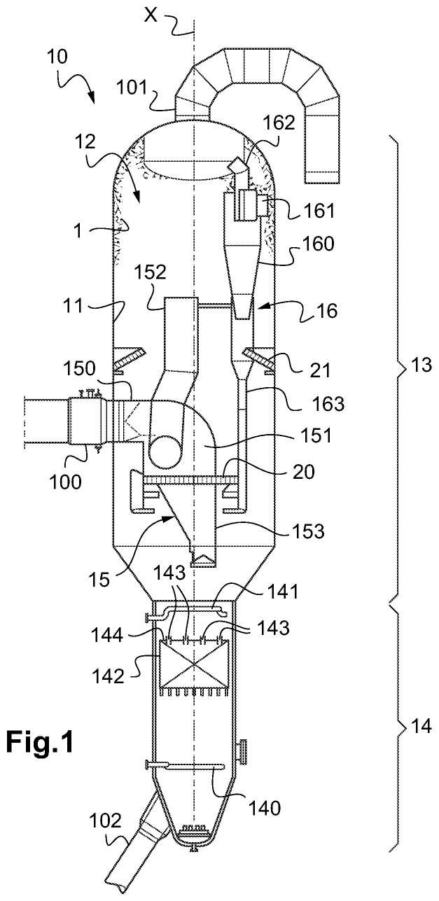

FIG. 1 shows a longitudinal section of a separation and stripping enclosure according to one embodiment.

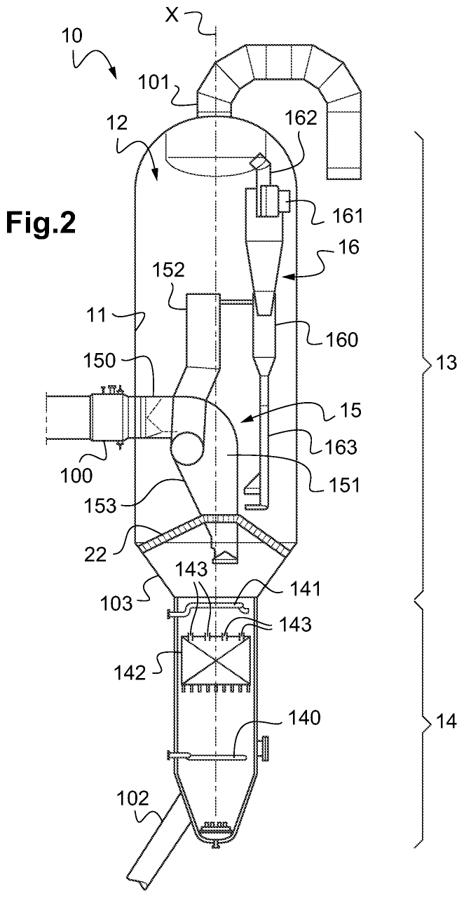

FIG. 2 shows a longitudinal section of a separation and stripping enclosure according to another embodiment.

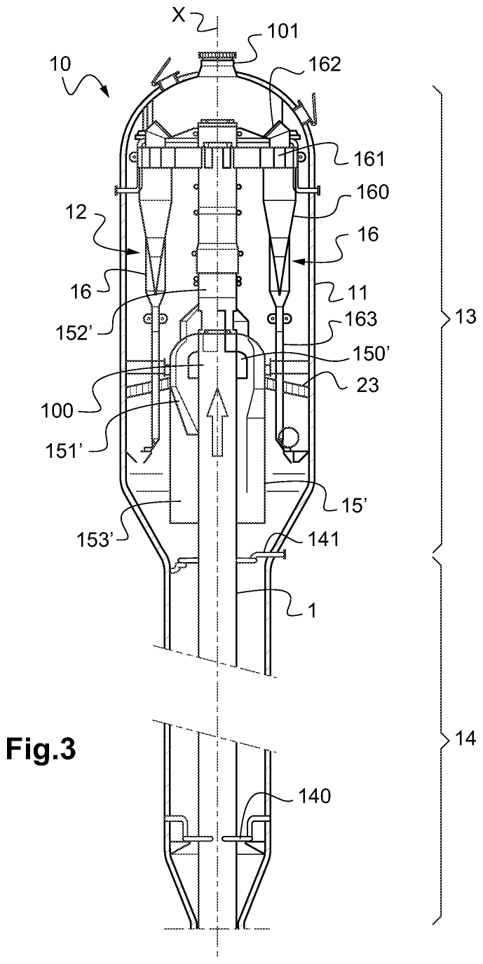

FIG. 3 shows a longitudinal section of a separation and stripping enclosure according to yet another embodiment.

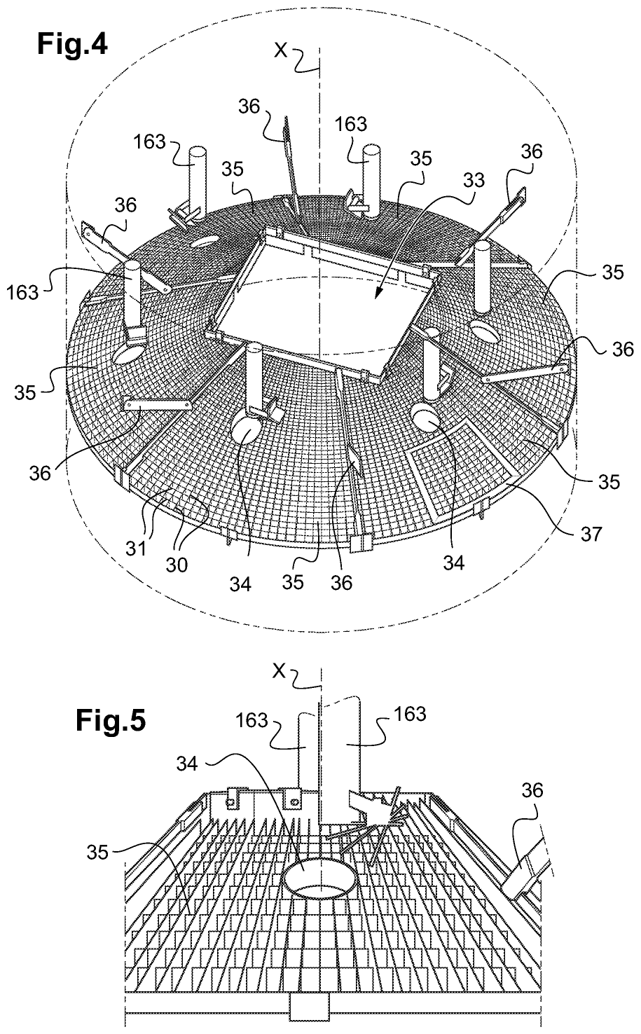

FIG. 4 shows a perspective view of a grille according to one embodiment.

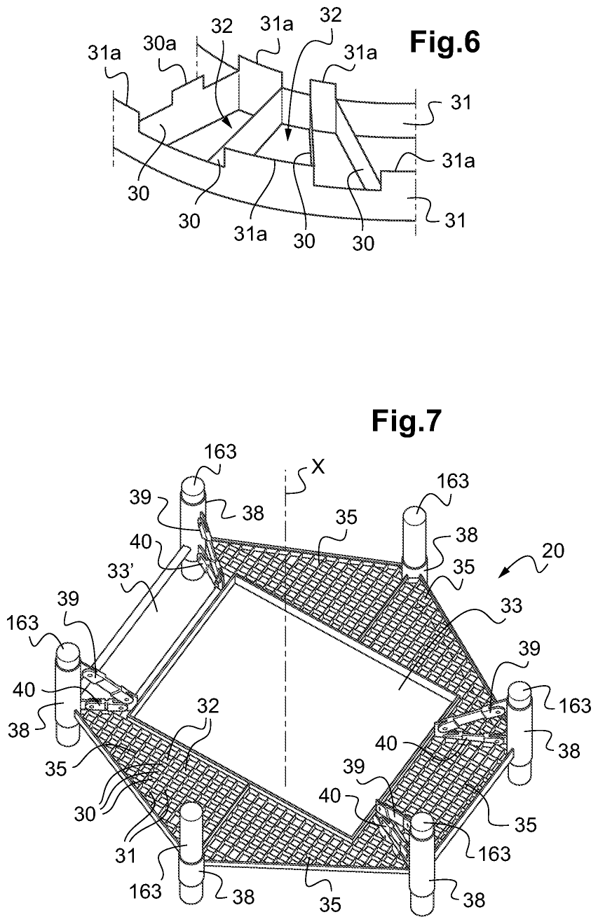

FIGS. 5 and 6 show enlarged views of a part of the grille of FIG. 4.

FIG. 7 shows a perspective view of a grille according to another embodiment.

In the present description, the terms upper, lower, above, below refer to a vertical or substantially vertical direction, in the direction of gravity, corresponding to the longitudinal direction of the enclosure in its usual position of use.

Substantially horizontal, longitudinal or vertical means a direction/a plane forming an angle of no more than ±20°, or even no more than 10° or no more than 5° with a horizontal, longitudinal or vertical direction/plane.

Substantially parallel, perpendicular or at right angles means a direction/angle differing by no more than ±20°, or even no more than 10° or no more than 5° from a parallel or perpendicular direction or from a right angle.

FIGS. 1 to 3 show a separation and stripping enclosure 10. This type of enclosure is used for treating an effluent containing particles, in particular coming from a fluidised-bed catalytic cracking reaction. This enclosure 10 forms for example part of a fluid catalytic cracking unit. The enclosure 10 has a side wall 11, here roughly cylindrical in shape but the lower part of which has a smaller diameter than the upper part. The invention is however not limited to an enclosure of any particular form. This side wall 11 delimits an internal volume 12 having a longitudinal axis X parallel to the plane of FIGS. 1-3.

In the usual manner, an internal cross section of the enclosure designates a cross section of the enclosure perpendicular to the longitudinal axis X.

In the conventional manner, the enclosure 10 comprises an inlet 100 for the effluent to be treated, a top outlet 101 for the separated gaseous effluent and a bottom outlet 102 for the solid particles. In the embodiments in FIGS. 1 and 2, the inlet 100 emerges inside the enclosure 10 radially (horizontally). In the embodiment in FIG. 3, this inlet 100 emerges inside the enclosure axially (vertically), a reactor 1 extending axially inside the enclosure 10.

The enclosure 10 comprises, inside its internal volume, a separation section 13 and a stripping section 14 for the particles located downstream of the separation section with respect to the circulation of the particles inside the enclosure. This circulation of particles typically takes place from top to bottom. In the separation section 13, the solid particles are separated from the gaseous fluids contained in the effluent entering the enclosure 10. For this purpose, the separation section comprises at least one separation device, generally several. These separation devices, which may or may not be directly connected to the outlet of the catalytic cracking reactor, are essentially separators of the ballistic or centrifugation type, which impart a rotation movement to the suspension, so that the particles separate from the gas by centrifugal effect. Typically, a separation section includes two stages of separation devices of the cyclone type or a primary separation device (of the QTS or RSS type described below) and one or two stages of separation devices of the cyclone type. The invention is however not limited to a particular type of separation device.

In the example shown in FIGS. 1 and 2, a ballistic separation device 15 with horizontal winding axis is disposed substantially at the centre of the enclosure and receives the effluent loaded with particles entering the enclosure 10 via the inlet 100. A plurality of separation devices 16 of the cyclone type (referred to as cyclones hereinafter) are distributed around the longitudinal axis and receive as an input the gaseous flow emerging from the separation device 15. The separation section thus comprises a primary separation device 15 and a cyclone stage 16.

The separation device 15 is here of the QTS type (quarter turn separator) and has an inlet 150, a body 151, an outlet 152 extending parallel or substantially parallel to the longitudinal axis X above the body 151 for discharging the gaseous fluids with low residual particle content, and a lower discharge conduit 153 for discharging particles and a little gaseous fluid to the stripping section 14. This outlet 152 is connected to the inlet 161 of the separation devices 16 detailed hereinafter.

In the example shown in FIG. 3, the separation section 13 is equipped with a ballistic separation device 15′ of the RSS type (riser separator system—a separation device for a reactor, connected to the outlet end thereof). This type of separation device 15′ is positioned centrally, along the longitudinal axis. This device 15′ also comprises an inlet 150′, a body 151′, an outlet 152′ extending parallel or substantially parallel to the longitudinal axis X above the body 151′ for discharging the gaseous fluids with low residual particle content to the cyclones 16, and a lower discharge conduit 153′ for discharging the particles and a small amount of gaseous fluid to the stripping section 14. The separation section also comprises here a primary separation device 15′ and a cyclone stage 16.

Cyclones 16 are well known devices and comprise an enclosure, generally essentially cylindroconical, designed to impose a rapid rotation on the gas and on the particles that it contains introduced into the body, for example by causing the gas loaded with solid particles to enter tangentially to the circumference of the enclosure, in the vicinity of the wall. Under the effects of centrifugal force, the solid particles taken in the vortex move towards the wall, lose their speed there by friction and fall into the lower part of the apparatus, before leaving through the apex of the cone. The gas follows the wall as far as the vicinity of the apex and, once the particles have been removed, rises to the upper part to leave through a discharge conduit, which partly projects inside the enclosure.

A cyclone thus normally comprises:
a separation enclosure 160, which generally comprises a cylindrical upper part and a conical lower part,
a first inlet conduit 161 emerging inside this separation enclosure, located at the upper part thereof,
a second gas outlet conduit 162 located at the upper part of the separation enclosure, and
a third particle discharge conduit 163 located at the lower part of the separation enclosure, also called “dipleg”, which extends parallel or substantially parallel to the longitudinal axis X. The end of this discharge conduit is generally equipped with a valve regulating the flow of particles towards the stripping section 14 and maintaining a particle level above the latter.

In the stripping section 14, the particles emerging from the separation section 13 undergo stripping during which the hydrocarbons trapped in these particles are extracted by means of a gaseous stripping fluid, generally steam. For this purpose, a stripping section 14 normally comprises a main injection system 140 for stripping fluid disposed in the lower part of the stripping section. Other stripping-fluid injection systems can be provided upstream of the main injection system 140. Here, a secondary injection system 141 is positioned at the inlet of the stripping section 14, to implement a pre-stripping of the particles before they enter the stripping section. In addition, the stripping section 14 is usually equipped with stripping elements that can extend in one or more stages upstream of the main injection system 140. In the example shown, stripping elements of the structured packing type occupy the zone 142 of the stripping section 14. The particles circulating from top to bottom enter the zone 142 through openings 143 defined by an inlet face 144 thereof, this inlet face extending transversely to the longitudinal axis X. These openings 143 are shown schematically in FIGS. 1 and 2 and correspond for example to the openings 143 of a stripping element located furthest upstream, namely at the inlet, in the zone 142.

The stripping section 14 generally corresponds to the part of the enclosure 10 of reduced cross section.

In a separation and stripping enclosure 10, in particular of the type shown on FIGS. 1 to 3, there may be deposits of coke 1 on the upper level of the side wall 11, as shown schematically on FIG. 1. Pieces of coke may detach, fall and reach the stripping section 14. Debris of refractory material covering the side wall may also fall in the same way.

In order to avoid the accumulation of this debris in the stripping section 14, the invention makes provision for positioning, upstream of the stripping section 14 or of a zone 142 of the stripping section provided with stripping elements extending across the internal cross section of the enclosure, at least one grille 20, 21, 22, 23 extending transversely to the longitudinal axis.

The grille or grilles thus have the function of retaining the debris falling inside the enclosure 10 in order to prevent it entering the stripping section 14. They are therefore disposed rather in the separation section 13, preferably upstream of the end of a discharge conduit of one or more (or even all) of the separation devices present in the separation section. However, the grille or grilles could be placed in the stripping section, upstream of the zone 142 containing stripping elements, for example between the secondary injection system 141 and this zone 142, or even distributed over the height of the enclosure upstream of the zone 142 or of the stripping section.

Furthermore, the form and the dimensions of the grille or grilles will be selected so that the projection of a single grille (grilles 22 or 23 in FIGS. 2 and 3) or of all the grilles (grilles 20 and 21 in FIG. 1) on a transverse plane perpendicular to the longitudinal axis covers 80 to 100% of the internal cross section of the enclosure. It should be noted that the grilles may be partly superimposed along the longitudinal axis (in other words the projections thereof may partly overlap), or not.

Generally, according to the invention, the grille or grilles are thus “bare” grilles that do not support functional elements or functional particles on their surface. In other words, no bed of particles or no assembly of functional elements rests on these grilles, only any pieces of coke or other debris initially attached to the side wall of the enclosure or of internal equipment of the enclosure are liable to be supported by the grille or grilles. It is therefore not necessary to provide a reinforced structure for this type of grille other than to ensure the integrity thereof when debris falls and to support the total weight of the grille and debris until the end of the cycle of the FCC unit (defined as the period between two planned maintenance stoppages). Typically, it will thus be possible to produce a grille around ten centimetres in height.

In the embodiment shown on FIG. 1, two grilles 20, 21 are disposed in the separation section 13. A first grille 20 is placed level with the discharge conduits 163 of the cyclones 16 and extends between these centrally. This grille 20 does not extend radially beyond the discharge conduits 163, in particular, in this example, the projection thereof onto a transverse plane perpendicular to the longitudinal axis X covers a central part of the enclosure 10 extending radially from the longitudinal axis towards the side wall 11 of the enclosure. This grille 20 is here a planar grille that extends in a plane perpendicular to the longitudinal axis X and is secured solely to the discharge conduits 163 of the cyclones 16.

Another grille 21 is placed higher along the longitudinal axis X, above the inlet 100 of the enclosure. This grille 21 is in the form of a truncated cone splaying from upstream to downstream with respect to the circulation of the particles, in particular, in the example, the projection thereof onto a transverse plane perpendicular to the longitudinal axis X covers an annular peripheral part of the enclosure 10 extending radially from the side wall 11 of the enclosure towards the longitudinal axis X, here over a distance enabling the parts 152, 160 of the separation devices 15 and 16 respectively to pass, present at this point in the enclosure 10. This grille 21 is here secured solely to the side wall 11.

In the embodiment shown on FIG. 2, a single grille 22 is disposed around the separation device 15, under the discharge conduits 163 of the cyclones 16. The grille 22 is in the form of a truncated cone splaying from upstream to downstream with respect to the circulation of the particles, in particular, in the example, the projection thereof onto a transverse plane perpendicular to the longitudinal axis X covers an annular peripheral part of the enclosure 10 extending radially from the side wall 11 of the enclosure towards the longitudinal axis X, here over a distance enabling the part of the separation device 15 present at this point in the enclosure 10 to pass, namely the discharge conduit 153. This grille 22 is thus similar to the grille 21 of FIG. 1, but is located lower in the enclosure 10, at a conical part 103 of the side wall 11, located here in the lower part of the separation section 13. The grille 22 can here come to rest on the side wall 11 of the enclosure 10.

In the embodiment shown in FIG. 3, a single grille 23 is disposed in the separation device 15′, this grille 23 having the discharge conduits 163 of the cyclones 16 and the body 151′ of the separation device 15′ passing through it. This grille 23 is in the form of a truncated cone splaying from upstream to downstream with respect to the circulation of the particles. In particular, in the example, the projection thereof onto a transverse plane perpendicular to the longitudinal axis X covers an annular peripheral part of the enclosure 10 extending radially from the side wall 11 of the enclosure towards the longitudinal axis X, here over a distance enabling the part 150 of the separation device 15 to pass. Furthermore, the grille 23 has orifices for the discharge conduits 163 and the body 151′ to pass. This grille 23 is here attached solely to the side wall 11.

The grilles are now described in more detail with reference to FIGS. 4 to 7.

The top grille 21 shown in FIG. 1 and the single grille 22, 23 in FIGS. 2 and 3 is in the form of a cone, here a truncated cone, splaying from upstream to downstream with respect to the circulation of the particles. This grille extends over 360° around the longitudinal axis. This type of grille is shown on FIGS. 4 to 6 and is formed by a plurality of intersecting walls 30, 31 defining meshes 32. Among these walls, walls 30 extend radially while the other walls 31 are annular walls centred on the longitudinal axis X. The invention is however not limited to a particular relative arrangement of these walls 30, 31 provided that they define meshes 32. These walls 30, 31 extend parallel or substantially parallel to the longitudinal axis X in order not to disturb the circulation of the flows inside the enclosure 10. Adjacent meshes 32 may then have wall portions 30a, 31a with different heights measured parallel to the longitudinal axis, as shown on FIG. 6. Higher wall portions can extend over the entire dimension of the wall of a mesh such as the portions 31a shown on FIG. 6, or over a part of this dimension, such as the portions 30a in FIG. 6. The dimensions of the meshes 32 can be selected so as to let pass only smaller pieces than the openings 143 of the inlet face 144 of the zone 142 of the stripping section 14. The dimensions of these meshes, measured in a plane perpendicular to the longitudinal axis, will thus preferably be selected smaller than the dimensions of an opening 143 of the stripping zone, measured in a plane perpendicular to the longitudinal axis.

The grille shown on FIGS. 4 to 6 is attached solely to the lateral wall 11 of the enclosure. It includes a central orifice 33 for here the separation device 15, 15′ to pass. This central orifice 33 has a rectangular shape corresponding to the shape of the cross section of the separation device 15, 15′. The central orifice will be such that an expansion clearance between the grille and the separator 15 will be maintained under all circumstances to allow free differential thermal expansion between the grille and the separator during the operation of the FCC unit. The grille also includes a plurality of orifices 34 distributed around the longitudinal axis X. These orifices 34 are here circular and can serve either for the discharge conduits of the cyclones 16 to pass, for example for the grille 23 in FIG. 3, or to facilitate the descent of the particles leaving these discharge conduits 163, when the grille is located under these conduits, such as the grille 22 in FIG. 2.

For a simpler installation, the grille is formed by a plurality of portions 35, here forming sectors 35, assembled on each other through their radial sides. This assembly can be implemented by keys, bolts, by interlocking, or any other suitable means or by a combination of these means. On FIG. 4, six sectors 35 are provided. The grille is furthermore attached to the lateral wall 11 of the enclosure by a plurality of struts 36 extending from a radius of the grille as far as the side wall, on the top of the grille. In the example shown on FIG. 4, a strut 36 is provided at each radial junction between two sectors. It will also be possible to provide a grille part forming a gate 37 for a man to pass, this grille part 37 being articulated on the grille by one of its sides in order to be able to be lifted upwards.

The bottom grille 20 shown on FIG. 1 is a planar grille that extends in a plane perpendicular to the axis of the enclosure. This type of grille is shown on FIG. 7. This grille 20 differs from the other grille described with reference to FIGS. 4 to 6 only through the fact that it is planar and that it does not extend all around the axis. The same references thus designate the same elements. Thus, because of the flatness of the grille, the walls 30, 31 can intersect at a right angle and define rectangular- or square-shaped meshes 32. The dimensions of the meshes 32 can be selected as described previously. Moreover, as with the other type of grille, the walls 30, 31 extend parallel or substantially parallel to the longitudinal axis X. It will also be possible to provide meshes having wall portions of different heights to promote the holding of the debris on the surface of the grille. The grille 20 also has a central orifice 33 for the separation device 15 to pass and in addition a side orifice 33′ located under the separation device 15. It is in fact not necessary (although possible) to provide a grille under the separation device 15 since the latter will divert the fall of the debris on its periphery. Thus, the grille 20 does not extend over 360° around the longitudinal axis X, but rather over 300°. The grille 20 is also formed by a plurality of portions 35, here five in number, assembled on each other along radially extending edges. In this embodiment, the grille 20 is attached solely to the discharge conduits 163 of the cyclones 16, here by sleeves 38 surrounding these conduits and secured thereto, supporting the grille directly or through struts 39, 40, some of which extend in the plane of the grille (struts 40) and the others are inclined upwards from the grille towards a sleeve 38 (struts 39). In the example, the grille 20 is attached by struts to four of the discharge conduits 163, disposed symmetrically with respect to the longitudinal axis X.

Thus it will be understood that the form and the dimensions of the grille or grilles will be adapted according to the equipment other than grilles present inside the enclosure and in particular above the lowest grille, namely the proximal grille of the stripping section 14 or of its zone 142. In particular, the form and the dimensions of the grille or grilles will be selected so that, seen from above along the longitudinal axis, the whole of the internal cross section of the enclosure (or at least 80%) is covered by the grille or grilles. When the enclosure comprises internal equipment other than the grille or grilles, typically one or more separation devices, or even a reactor, then the form and the dimensions of the grille or grilles will be selected so that, seen from above along the longitudinal axis, the whole of the internal cross section of the enclosure (or at least 80%) is covered by the grille or grilles and the item or items of internal equipment.

1. Enclosure for separating and stripping an effluent containing particles, including a side wall delimiting an internal volume having a longitudinal axis and, inside the internal volume, a separation section and a stripping section for the particles located downstream of the separation section with respect to the circulation of the particles inside the enclosure, characterised in that it comprises, upstream of the stripping section or of a zone of the stripping section provided with stripping elements extending across the internal cross section of the enclosure, at least one grille extending transversely to the longitudinal axis, in that the projection of a single grille or of all the grilles onto a transverse plane perpendicular to the longitudinal axis covers 80 to 100% of the internal cross section of the enclosure, and in that said at least one grille is formed by a plurality of intersecting walls defining meshes and in that adjacent meshes have wall portions of different heights measured parallel to the longitudinal axis.

2. Enclosure according to claim 1, characterised in that the projection of a single grille or of all the grilles onto a transverse plane perpendicular to the longitudinal axis covers from 80 to 100% of the surface of a free internal volume of the enclosure projected along the longitudinal axis in the plane of the single grille or in the plane of the proximal grille of the stripping section or of the zone of the stripping section provided with stripping elements, the free internal volume being defined as a part of the internal volume of the enclosure with no equipment other than a grille and located upstream of the single grille or of the proximal grille.

3. Enclosure according to claim 1, characterised in that said at least one grille extends continuously over at least 300° around the longitudinal axis and the projection thereof onto a plane perpendicular to the longitudinal axis covers at least a part of the internal cross section of the enclosure and extends radially over at least a part of the distance separating the longitudinal axis from the side wall of the enclosure.

4. Enclosure according to claim 1, characterised in that the projection of said at least one grille covers a part of the internal cross section of the enclosure extending radially over a part of the distance separating the longitudinal axis from the side wall of the enclosure, optionally selected from:
a central part extending radially from the longitudinal axis towards the side wall of the enclosure, and
an annular peripheral part extending radially from the side wall of the enclosure towards the axis thereof.

5. Enclosure according to claim 1, wherein the zone of the stripping section has an inlet face defining openings in a plane perpendicular to the longitudinal axis, characterised in that said at least one grille is formed by a plurality of intersecting walls defining meshes and in that the dimensions of a mesh, measured in a plane perpendicular to the longitudinal axis, are smaller than the dimensions of an opening of the zone of the stripping section, measured in a plane perpendicular to the longitudinal axis.

6. Enclosure according to claim 1, characterised in that said at least one grille is formed by a plurality of intersecting walls defining meshes and in that these walls extend parallel or substantially parallel to the axis of the enclosure.

7. Enclosure according to claim 1, characterised in that said at least one grille is selected from:
a grille having a cone or truncated cone shape splaying from upstream to downstream with respect to the circulation of the particles,
a planar grille that extends in a plane perpendicular to the longitudinal axis.

8. Enclosure according to claim 1, characterised in that said at least one grille is attached solely to the side wall of the enclosure.

9. Enclosure according to claim 1, characterised in that the separation section comprises a plurality of separation devices distributed around the longitudinal axis and in that said at least one grille is attached solely to at least two separation devices, optionally to each of the separation devices.

10. Enclosure according to claim 9, characterised in that said at least one grille does not extend beyond the separation devices radially.

11. Enclosure according to claim 9, wherein the separation devices are each provided with a conduit for discharging particles to the stripping section and characterised in that said at least one grille is attached solely to at least two discharge conduits, optionally to each discharge conduit.

12. Enclosure according to claim 1, characterised in that the separation section comprises at least one separation device and in that said at least one grille includes at least one orifice through which said at least one separation device passes.

13. Enclosure according to claim 1, characterised in that the separation section comprises at least one separation device provided with a conduit for discharging the particles to the stripping section and in that said at least one grille is located downstream of the discharge conduit and includes an orifice located under this discharge orifice in a direction parallel to the longitudinal axis.

14. Enclosure according to claim 1, characterised in that the separation section comprises at least one separation device provided with a conduit for discharging particles and in that said at least one grille is located upstream of one end of the discharge conduit.
